(19) United States
(12) Patent Application Publication
(10) Pub. No.: US 2026/0154432 A1
(43) Pub. Date: Jun. 4, 2026

(54) CONTEXTUALIZED FILTERING OF LARGE LANGUAGE MODEL CONTENT

(71) Applicant: SAP SE, Walldorf (DE)

(72) Inventors: Kavitha KRISHNAN, BANGALORE (IN); Shashank Mohan JAIN, KARNATAKA (IN)

(21) Appl. No.: 18/965,417

(22) Filed: Dec. 2, 2024

(51) Int. Cl. G06F 21/62; G06F 16/3329; G06F 16/338

(52) U.S. Cl. CPC G06F 21/6218; G06F 16/3329; G06F 16/338

(57) ABSTRACT

In some implementations, there is provided a computer-implemented method including receiving a query to grant user access to content generated by a large-language model, the query including a user identifier; verifying, based on the user identifier and using a first filter of a filter pipeline, a clearance level associated with the user identifier; granting, based on the verifying, the user access to at least a subset of the content generated by the large-language model; verifying, using at least a second filter of the filter pipeline, a temporal context of the query and a spatial context of the query, the temporal context comprising a time at which the query is received and the spatial context comprising a location from which the query is received; and providing, based on the verifying of the clearance level, the temporal context, and the spatial context, content generated by the large-language model.

### TECHNICAL FIELD

The present disclosure relates to filtering content generated by a large-language model (LLM) based on the context of a user query.

### BACKGROUND

LLMs receive a query, such as a prompt or text request, as input and provide a responsive output based on the query. The LLM may be trained on various sources, and these sources may provide the responsive output to the user. The sources may include for example text, documents, webpages, emails, or other company-specific sources including internal portal webpages, policy pages, and documents from shared workspaces. Some company-specific sources may contain confidential, restricted, or privileged information, in which case the information may only be accessible by certain users (e.g., employees of the company) having specific roles and/or clearances within the company. Some company-specific sources may contain information that is only relevant to a portion of the company's employees based on a time frame and/or a geographic location at which a query is submitted to the LLM. In the case, of retrieval-augmented generation (RAG), the query is augmented with additional information from an additional source (e.g., with before the query is submitted to an LLM. This augmented query may enable the LLM's responsive output to be enhanced or optimized.

### SUMMARY

In some embodiments, there is provided a computer-implemented method, the method comprising: receiving a query to grant user access to content generated by a large-language model, the query including a user identifier; verifying, based on the user identifier and using a first filter of a filter pipeline, a level of clearance associated with the user identifier; granting, based at least on the verifying, the user access to at least a subset of the content generated by the large-language model; verifying, using at least a second filter of the filter pipeline, a temporal context of the query and a spatial context of the query, wherein the temporal context comprises a time at which the query is received and wherein the spatial context comprises a location from which the query is received; and providing, based at least on the verifying of the level of clearance and the verifying of the temporal context and the spatial context, at least the subset of content generated by the large-language model.

In some variations, one or more features disclosed herein including one or more of the following features may be implemented as well. The user identifier may comprise one or more of a login identifier, a time, or a location. The query may be received from a user interface from which the query is generated. The verifying the level of clearance associated with the user identifier may comprise comparing a first vector embedding corresponding to the user identifier to a second vector embedding corresponding to a source on which the large-language model is trained. The granting of the user access to at least the subset of the content generated by the large-language model may comprise including the subset of the content in a query response. The providing at least the subset of content generated by the large-language model may comprise providing a query response to a user interface. The method may comprise training the large-language model using at least in part one or more documents that are non-public and/or confidential to an entity.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods may be implemented by one or more data processors either within a single computing system or distributed among two or more computing systems. Such computing systems may be connected and may exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a block diagram of a system that provides contextualized filtering of LLM content, in accordance with some example implementations of the current subject matter;

FIG. 2 illustrates a diagram of a process flow for contextualized filtering of LLM content, in accordance with some example implementations of the current subject matter; and

FIG. 3 illustrates a block diagram of another example of a system, in accordance with some example implementations of the current subject matter.

### DETAILED DESCRIPTION

Access to content generated by large-language models (LLMs) may be restricted or prevented based on, for example, a role of a user attempting to access the LLM's content. Consistent with implementations described herein, if an LLM is trained using certain confidential, proprietary, or restricted sources of information (referred to herein as “company-specific sources”) only entities or users of the LLM having a certain role-based clearance may access certain outputs of the LLM. Example of company-specific sources include documents containing confidential information about new product launches, trade secret information, employee information, and/or other non-public company information.

For example, a company's CEO using the LLM (which generates output based on company-specific sources) may have a role-based clearance level that is sufficient to access all of the company's documents. Because the LLM is trained on these documents, the CEO submitting a query or request to the LLM should have complete access to the possible outputs of the LLM. On the other hand, a new company employee may lack the role-based clearance to access certain documents (such as documents containing information on, for example, other employees). As a result, the new employee submitting a query to the LLM may only receive outputs containing information sourced from the documents on which the LLM is trained and to which the user's role-based clearance level provides access. This restricting or curtailing of access to content made by LLM (which is trained on company-specific documents) may prevent users from accessing information for which they lack sufficient role-based clearance.

To illustrate further, the company-specific information (e.g., documents and the like) may be used to train an LLM, and the company-specific information may also include information that is only relevant to certain employees at a particular time and/or a particular geographic location. When this is the case, RAG can be used to optimize the output of the LLM, and spatial context filtering and/or temporal context filtering of the LLM's output may also be used to provide responses (e.g., the LLM's output) to queries of the LLM. Such responses are filtered to restrict the responsive information based on role-based clearance, time, and/or geographic location.

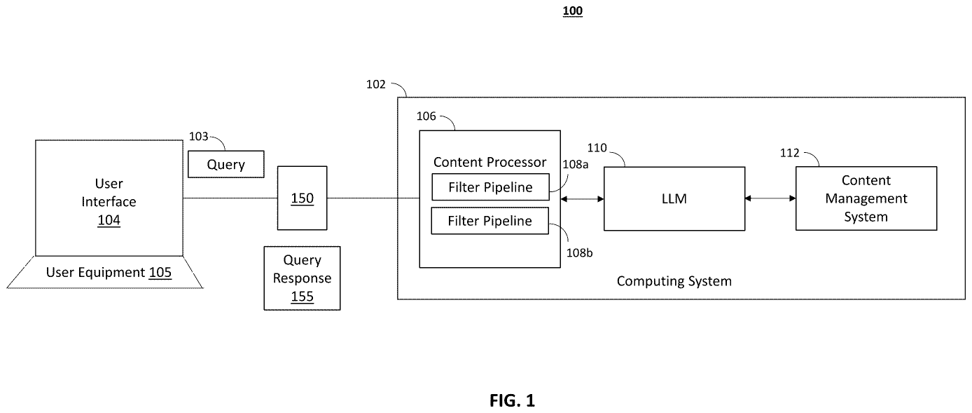

FIG. 1 depicts an example of a system 100 consistent with implementations of the current subject matter. The system 100 may include a user equipment 105, such as a computer, laptop, smartphone, tablet, and/or the like. The user equipment 105 may further include a user interface 104. The user equipment 105 may couple, via network 150 (e.g., the Internet and/or any other communication mechanism), to a computing system 102 comprising one or more processors and one or more memory.

The computing system 102 may include a content processor 106 configured to apply one or more filter pipelines, such as a filter pipelines 108a and 108b, to queries received by an LLM 110 and to content that is output by an LLM 110. The computing system 102 may also include a content management system 112 that manages, stores, or contains one or more documents, including, for example company-specific documents. Each of filter pipelines 108a and 108b comprises at least a first filter. Each of filter pipelines 108a and 108b may comprise any number of filters, as described herein.

In some implementations, filter pipeline 108a may apply at least a first filter to a query 103 received from user interface 104 such that a limited amount of content is sourced from the content management system 112 and output by LLM 110. In certain implementations, filter pipeline 108b may apply at least a first filter to output of LLM 110 trained on the content management system 112 in response to a query 103 such that a query response 155 is only based on a subset of content from the content management system 112. As further described below, the subset of content from the content management system 112 on which a query response 155 to query 103 is based may be content in content management system 112 having a vector embedding corresponding to a vector embedding describing the query 103. Although FIG. 1 depicts the content processor 106, LLM 110, and the content management system 112 within a single computing system, the content processor 106, LLM 110, and/or the content management system 112 may be hosted at other locations. For example, the LLM 110 may be hosted on a cloud platform and accessed by via a network, such as network 150.

Referring again to the content processor 106, it is configured to apply a filter pipeline 108a to a query that is received from user interface 104 and/or a filter pipeline 108b to content that is output by the LLM 110 before providing the LLM's output to the user interface 104. For example, when a query 103 is sent from the user equipment 105 towards the LLM 110 for a response, the query may be intercepted by the content processor 106 including the filter pipeline 108a to provide output from LLM 110 based on a subset of relevant content from content management system 112 in response to the query 103. In some implementations, when a query 103 is sent from the user equipment 105 towards the LLM 110 for a response, the LLM's output (which is in response to the query) may be intercepted by the content processor 106 including the filter pipeline 108b to filter certain aspects of the LLM's output responsive to the query 103.

The LLM 110 may, as noted, be trained on one or more electronic documents (which are generally referred to as “documents”) contained in, managed by, and/or stored by the content management system 112 (CMS). Some of the documents may be “company-specific documents”. In the case of the company-specific documents (which are part of the content management system 112), some of the documents may be proprietary, confidential, private, or otherwise of a type that should not be broadly disseminated or shared with all of the employees of a given company (or with the public for that matter). To illustrate, the company-specific documents may include private or sensitive employee information. In this example, access to the sensitive employee information may be restricted based on role of the user making a query (e.g., certain human resource users making a query 103).

One or both of the filter pipelines 108a and 108b may be configured to restrict access to content output by LLM 110 (which is in response to the query 103). This restriction may be implemented by applying a filter pipeline 108a to a query that is received from user interface 104 and/or by applying a filter pipeline 108b to content that is output by the LLM 110 before providing the LLM's output to the user interface 104.

In the first instance, the computing system 102 accesses only a subset of the information in the content management system 112 in a response from LLM 110 and provides the relevant information from the subset to the user equipment 105 responsive to the query. The computing system 102 may determine which subset of information from content management system 112 to access by comparing a vector embedding describing the query 103 to vector embeddings describing the documents or information stored in content management system 112. Alternatively, in the instance where a filter pipeline 108b is applied to content that is output by the LLM 110, the computing system 102 may access a set of information from content management system 112 and may filter the information in the set that is sent from the content management system 112 to LLM 110 by comparing a vector embedding of the query 103 to a vector embedding describing the information or content stored in content management system 112.

In both instances, the result is that the filtered information from the content management system 112 can thus be provided with the query response 155. By applying the filter pipeline 108a to the query 103 prior to accessing information from content management system 112, computing resources can be saved as less information may be drawn from content management system 112. By filtering the output of content management system 112 using filter pipeline 108b, it can be ensured that the largest amount of relevant information is considered in the query response 155 provided to the user equipment 105. In certain implementations, either or both of filter pipelines 108a and 108b can be used to restrict access to content output by LLM 110, depending on the computational resources available and the confidentiality of the information sourced from content management system 112.

The restriction applied by the filter pipelines 108a and 108b may be based on at least a level of confidentiality of the company-specific document's information and the authorization (e.g., clearance) of a user at the user equipment 105 attempting to access the information. For example, an employee, a manager, a purchaser, and a purchasing manager may all have different clearance or authorization levels based on their roles and the different tasks that each role performs. To illustrate further, certain legal documents in the content management system 112 may be role-specific and may thus be accessible only by certain users having certain roles. In some implementations, the filter pipelines 108a and 108b may be configured to apply a role-based access control (RBAC) filter to query 103 and/or to content output by LLM 110 based on the clearance of the user of user interface 104.

In some implementations, a user accessing the user interface 104 may submit towards the computing system 102 a query 103 (e.g., a request) that requests certain content from computing system 102. For example, the query 103 that is sent toward computing system 102 may be of the form “Please list all employees that work remotely and have a poor performance evaluation.” The query 103 may also include a user identifier (e.g., a userID, login identifier (loginID), employee ID, or other identifier) of the of the user making the query 103.

When the query 103 is received by computing system 102, the computing system 102 may identify a clearance level or authorization of the user accessing the user interface 104 to make the query 103. For example, the content processor 106 may access a database listing authorization or clearance information or rules for a plurality of users. When this is the case, the content processor 106 may use the userID included in the query 103 to determine the authorization level or clearance of the user associated with the query 103 based on the authorization or clearance information or rules. Alternatively, or additionally, the query 103 may include metadata that expressly indicates the clearance level or authorization level of the user associated with the query 103. The processor 106 may verify the level of clearance or authorization of the user associated with the query 103. Based on the verification of the user's clearance or authorization level, the filter pipeline 108a may create output of LLM 110 from a subset of information from the content management system 112. In some implementations, based on the verification of the user's clearance or authorization level, the filter pipeline 108b may modify the output of the LLM 110 (which is responsive to the query 103), so that only the output that is appropriate to the user's clearance or authorization level is forwarded as a query response 155 toward the user equipment 105 including user interface 104.

Referring to the previous example regarding the query that requests a list of all employees that work remotely and have poor performance evaluations, the filter pipeline 108a may restrict the user that submitted the query to accessing content from LLM 110 that is sourced only from a subset of information stored in the content management system 112. The content processor 106 and the filter pipeline 108a may use the user identifier (which was provided in the query 103) to determine the role of the user and, in this example, the authorization or clearance of the user to receive the sensitive human resources data. As such, if the content processor 106 maps the userID (of the user associated with the query 103) to an HR role, for example, the filter pipeline 108a will ensure that only the appropriate subset of information from the content management system 112 is used to provide query responses 155 from LLM 110. The filter pipeline 108a may comprise an object that filters tasks on the request to a resource (e.g., a servlet or static content) and/or on the response from a resource; an example of a filter is an Apache Tomcat server filter, although other types of filters may be used in filter pipeline 108a. The filter used in filter pipeline 108a may be configured with instructions that perform the authorization checks described herein.

Referring again to the previous example, in some implementations, on receiving the query, the LLM 110 may output to the content processor 106 and the filter pipeline 108b a list of all the employees of the company that work remotely and have poor performance evaluations. The content processor 106 and the filter pipeline 108b may use the user identifier (which was provided in the query 103) to determine the role of the user and, in this example, the authorization or clearance of the user to receive the sensitive human resources data. As such, if the content processor 106 maps the userID (of the user associated with the query 103) to an HR role, for example, the filter pipeline 108b will allow the LLM's output (e.g., the list of all the employees of the company that work remotely and have poor performance evaluations) to be provided as a query response 155. If, however, the content processor 106 maps the userID (of the user associated with the query 103) to a salesperson role for example, the filter pipeline 108b will restrict (e.g., filter out or block) the LLM's output (e.g., the list of all the employees of the company that work remotely and have poor performance evaluations) to be provided as a query response 155. Instead, the content processor 106 may respond via the query response 155 with “Not Authorized To View Content” for presentation via user interface 104.

The LLM 110's output may be modified by a first filter of filter pipeline 108a and/or 108b. The first filter of the filter pipelines 108a and 108b may be a role-based access control (RBAC) filter. This role-based access control (RBAC) filter may, as noted, restrict or block access to the LLM's output based on the role of the user associated with the query 103. In some implementations, the role-based access control filter may filter out a portion of the LLM's output while allowing some of the LLM's output to be provided as a query response. For example, if some of the LLM's output is allowed to be provided to the user (based on the user's role) while other portions of the LLM's output are filtered out (based on the user's role), the allowed portion of the LLM's content may be included in the query response 155 (without the filtered, disallowed portion). Computing system 102 outputs to user interface 104 at least a subset of the content generated by the LLM 110 and requested by the user.

The query 103 may indicate the requested information from the LLM and an identifier of the user (e.g., userID) associated with the query 103. Alternatively, or additionally, the query 103 may include or be associated with other metadata, such temporal information associated with the query 103 and/or spatial information (e.g., location-based or geographic) associated with the query 103.

Referring to the previous example regarding the query 103 that requests a list of all employees that work remotely and have poor performance evaluations, the query 103 may include or be associated with metadata, such as a time (or time frame) and a location. To illustrate further, the query 103 may be from an EU-based user that is making the query 103. In this example, the filter pipelines 108a and 108b may be configured to block all non-EU employees from the list. In another example, the query 103 may list a time frame, such as calendar year 2023, in which case the filter pipelines 108a and 108b may be configured to block content outside of that 2023 timeframe.

The filter pipelines 108a and 108b may be configured to successively apply one or more filters, such as contextual filters, to the output provided by the LLM 110. In some implementations, after applying the above-noted the RBAC filtering to the output of LLM 110, the filter pipelines 108a and 108b may also be configured to apply at least a second filter to the output of LLM 110. This second filter of the filter pipelines 108a and 108b may be a spatial filter that is configured to filter the query 103 or the output of LLM 110 based on location or region. As noted, the second filter of the filter pipelines 108a and 108b may be applied to the query 103 such that only limited information from the content management system 112 is used to generate responses from LLM 110. The second filter of the filter pipelines 108a and 108b may additionally or alternatively be applied to the output of LLM 110, such that all possible information from the content management system 112 is used to generate query responses. The query responses so generated may then be filtered prior to being provided to the user equipment 105 to ensure that they provide information having an appropriate access control.

Alternatively, or additionally, the second filter may be a temporal filter configured to filter the query 103 or the output of LLM 110 based on time. Alternatively, or additionally, the second filter may be a spatiotemporal filter configured to filter the query 103 or the output of LLM 110 based on time and location. For example, the metadata associated with the query 103 may indicate that the query was submitted at a user interface 104 at a certain time and from a particular location (e.g., from a certain office of a company having several offices). Based on this metadata, the filter pipelines 108a and 108b may filter (e.g., selectively block or allow) the query 103 or the output of LLM 110 before providing the query response 155. In some implementations, the documents in the content management system 112 may be represented or described by a corresponding vector embedding (e.g., a vector representation of the text in a document). The computing system 102 may generate for the query 103 a corresponding vector embedding. When the corresponding vector embedding for the query 103 is generated by the computing system 102, specific metadata can be added to the embedding. The metadata may include, for example, a timestamp or other temporal metadata. The metadata may also include, for example, a set of locations in which access to content in the content management system 112 should (or should not) be granted or other location-based metadata. During runtime query execution, the computing system 102 may determine which content of which documents in the content management system 112 is responsive to the query 103. This determination may be based on a comparison of the vector embedding describing the document to the vector embedding corresponding to the query 103 (e.g., a match or evaluation of a threshold distance between the two embeddings). In some implementations, each vector embedding for a corresponding document in the content management system 112 is associated with metadata (as noted herein) that may be compared to the metadata received with the query 103 to determine if the user that submitted query 103 should be able to access the vector embedding. The computing system 102 may determine the responsive documents from the content management system 112 using the filter pipelines 108a and 108b. A filter of one of the filter pipelines 108a and 108b may check, for example, whether the specific embeddings match the temporal metadata. Alternatively, or additionally, a filter of one of the filter pipelines 108a and 108b may check, for example, whether the location-based metadata satisfies geographical constraints imposed on the response to the query 103. For example, in response to the comparison of the location-based metadata of the vector embedding corresponding to the query 103 to the vector embedding describing the document stored in content management system 112, content can be blocked if it is deemed sensitive content in certain locations.

As an example of additional spatiotemporal contextual filtering of the query 103 or the output of LLM 110, the query 103 may request information on office closure policies for a company (e.g., the query may be “Tell me about upcoming office closures.”). The filter pipelines 108a and 108b may be configured to verify (using a first filter of the filter pipelines 108a and 108b) if, based on the metadata (e.g., userID, location, time, etc.) associated with query 103, the user associated with the query 103 has an authorization (e.g., clearance, permission, etc.) sufficient (e.g., equal to or above) for the level of authorization required to access the information about office closure policies. For example, office closure policies may be confidential if they are being finalized by company management.

The computing system 102 may be configured to determine spatiotemporal contexts of the query 103 including a time and a location associated with the query 103. The computing system 102 may determine spatiotemporal contexts of the query based on metadata associated with query 103. After determining the time of the submission of query 103 (e.g., using a time stamp of the query or a time when the query 103 is transmitted or received at the computing system 102), the computing system 102 may use at least a second filter of the filter pipelines 108a and/or 108b to provide more relevant information about upcoming office closures. For example, if a user of the system 100 submits the query 103 requesting information on office closure policies on December 23, the computing system 102 may modify the output of LLM 110 so that information about upcoming closures for Christmas is prioritized or alternative information from a prior year is filtered out. If the user submits the same query 103 requesting information on office closures on December 26, the computing system 102 may modify the output of LLM 110 so that information about upcoming closures for New Year's Day is prioritized. The computing system 102 may modify the output of LLM 110 based on a vector embedding describing the query 103. The modification of the output of LLM 110 helps to ensure that the response to query 103 is based only on relevant documents from the content management system 112. Relevant documents from the content management system 112 may be those having a vector embedding that corresponds to the vector embedding describing the query 103.

If the user associated with the query 103 is also associated with the company's Boston office on the second Monday of April, the computing system 102 may modify the output of LLM 110 so that information about upcoming closures for the third Monday of April (i.e., Massachusetts'Patriot Day holiday) is output as query response 155. A user submitting the same query from a company's New York office on the same second Monday of April may receive from computing system 102 output related to office closures at the end of May (e.g., Memorial Day, which may be the next relevant upcoming office closure for an employee in New York). By applying the successive filters of filter pipelines 108a and 108b of the output of LLM 110, a user of user interface 104 receives, responsive to their query 103, output from LLM 110 based on the most relevant content/information from the documents in the content management system 112 to which the user's clearance level provides them access.

In some implementations, the systems and methods described herein are used by companies looking to purchase goods or materials from suppliers. Purchasing policies may change over time. As such, the computing system 102 may provide the most recent and updated policies to a user that has submitted a query 103 regarding the company's purchasing policies.

In some implementations, purchasing policies and eligibility to information describing purchasing policies may vary based on location(s) across a company. Policy documents outlining such policies may vary accordingly. LLM 110 may be trained on such documents and may use the filter pipelines 108a and 108b to provide output to a user of computing system 102 that is relevant and that reflects the purchasing policies and eligibility for their location. During a procurement process, for example, a document, such as a contract (e.g., an electronic document or electronic contract), may be created between a buyer and a supplier. In this example, the document may comprise several pages of content. This content may include data, such as a supplier name, a start date of the contract, a purchasing unit, a price for a good and/or a service, and/or other terms, conditions, and/or the like. In this context, a role of document or contract manager may be assigned to one or more users allowed to have access to the document. The user having the contract manager role may only be able to access, for example, certain contract documents associated with (e.g., having a document property or information relevant to) the contract manager's purchasing unit. In other words, the contract manager may not have access to all contract documents associated with their purchasing unit. As such, the filter pipelines 108a and 108b may be configured to perform a verification of the access clearance of a given contract manager that submits a query 103 requesting content from the content management system 112. Based on a comparison of a first vector embedding (which describes the contract manager's access permissions that are indicative of the company's information to which the contract manager has access) to a second vector embedding (which describes the company information contained in a contract document in the content management system 112), the computing system 102 may output a query response 155 to query 103 that only contains company information from content management system 112 that the contract manager that submitted the query 103 has permission to access.

Additional contextual filtering may be performed in response to a user query 103 including contextual embeddings-based access control and predictive access control. In some implementations, context embeddings-based access control comprises including a user context (e.g., a user's access history) in an embedding associated with query 103. In certain implementations, contextual embeddings-based access control provides semantic-level control over user access by, for example, contextualizing the user's access history, comparing the access history to content in the content management system 112, and providing relevant output to the user based on the comparison. For example, the user's access history can be described by a vector embedding. This vector embedding may describe the content accessed by a user, as well as the times at which the content was accessed and the locations from which the content was accessed. The vector embedding may be compared to a vector embedding describing a user query, such as query 103. The computing system 102 may, based on the comparison, provide a query response 155 that includes content that has been previously accessed by the user and that is appropriate for sending in response to the query 103. In certain implementations, predictive access control comprises predicting which content of documents in the content management system 112 a user of computing system 102 may look for in the future. Such a prediction may be made, for example, based on historical patterns of embeddings received with user queries 103. Computing system 102 may then adapt and provide output of LLM 110 to a user based on such predictions. Computing system 102 can use the historical patterns of vector embeddings received with user queries 103 to prefetch content from content management system 112. The prefetching can be used as a speculative mechanism as to the content for which a user might ask. If a user submits a query 103 that asks for content that has been prefetched, the prefetched content can be served or else discarded after a certain time to live in a cache.

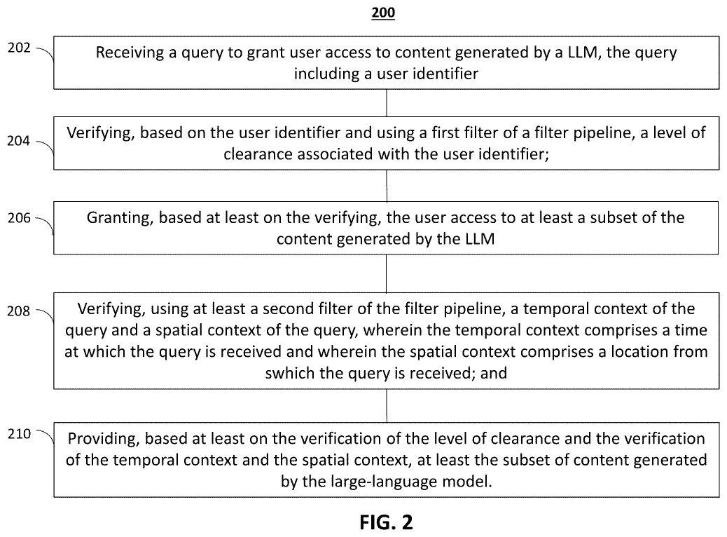

FIG. 2 depicts a process 200 (which may be a computer-implemented method) for contextual filtering of an LLM's output such as content or information. The description of FIG. 2 also refers to FIG. 1.

At 202, the process 200 may include receiving, from a user interface, a query to grant user access to content generated by a large-language model, the query including a user identifier, in accordance with some embodiments. For example, the query 103 may ask a question or request information that can be provided as content generated by the LLM 110. The query 103 may also represent a request to grant the user associated with the query 103 access to the content generated as an output of the LLM 110. As noted, some of the content provided by the LLM 110 may include documents, including, for example, company-specific documents or information contained, stored, or managed by the content management system 112. The query 103 may also include a user identifier associated with the user making the query 103. The user identifier may comprise, for example, a loginID or any other type of identifier. Alternatively, or additionally, metadata may be included in the query 103, such as metadata that describes the user's clearance level with respect to accessing the material described in the documents from the content management system 112 on which the LLM 110 is trained. Alternatively, or additionally, the metadata may include or provide location and/or time information associated with the query 103.

At 204, the process 200 may include verifying, based on the user identifier and using a first filter of a filter pipeline, such as filter pipelines 108a and 108b of FIG. 1, a level of clearance associated with the user identifier, in accordance with some embodiments. For example, the computing system 102 (e.g., the content processor 106) may use a first filter of the filter pipelines 108a and 108b to verify a level of clearance associated with the user identifier associated with the query 103. Moreover, the computing system 102 may verify the clearance level of the using an RBAC filter, which may be a first filter in the filter pipelines 108a and 108b. As described, a high-ranking company employee may have a higher clearance than a new, low-ranking company employee, and these clearances may be captured in metadata (e.g., the user identifier) sent with the query 103 to the LLM 110 by each of these company employees. The RBAC filter of filter pipelines 108a and 108b may ensure that a user of computing system 102 is only able to retrieve embeddings for documents in the content management system 112 that the user is authorized to access.

At 206, the process 200 may include granting, based at least on the verifying, the user access to at least a subset of the content generated by the large-language model, in accordance with some embodiments. For example, the computing system 102 may grant (based at least on the verifying of the level of clearance to access information in the content management system 112 associated with the user identifier) user access to at least a subset of the content generated by the LLM 110. This subset of the content may be included in the query response 155, while content that is blocked or filtered out is not provided in the query response 155. In some implementations, the level of clearance associated with the user identifier is high enough such that access may be granted to all content generated by the LLM 110. In certain implementations, the level of clearance associated with the user identifier is not high enough to be granted access to all content generated by the LLM 110. In some implementations, when the level of clearance associated with the user identifier is not high enough to be granted access to all content generated by the LLM 110, the computing system grants user access to a subset of the content generated by the LLM 110. The subset of the content generated by the LLM may be accessible by users having user identifiers that lack clearance to access all content output by the LLM 110.

At 208, the process 200 may include verifying, using at least a second filter of the filter pipelines 108a and 108b, a temporal context of the query and a spatial context of the query, wherein the temporal context comprises a time at which the query is received and wherein the spatial context comprises a location from which the query is received, in accordance with some embodiments. For example, the computing system 102 (e.g., content processor 106) may verify a temporal content of the query 103 and/or a spatial context of the query 103. The computing system 102 may verify the temporal and/or spatial contexts of the query 103 using at least a second filter of the filter pipelines 108a and 108b. In some implementations, the temporal context comprises a time at which the query 103 is received from user interface 104. In certain implementations, the spatial context comprises a location from which the query 103 is received from user interface 104. Based on the verification of the temporal context associated with the query 103, the computing system 102 may only include in the output of LLM 110 content/information of temporal relevance from the documents in the content management system 112 on which LLM 110 is trained. The computing system 102 may exclude, based on the verification of the temporal relevance of query 103, outdated content/information from the output of LLM 110. Similarly, based on the verification of the spatial context associated with the query 103, the computing system 102 may include in the output of LLM 110 only content/information of spatial (e.g., geographical) relevance to the user of user interface 104. The content of spatial and/or temporal relevance may be included in the query response 155.

At 210, the process 200 may include providing, based at least on the verification of the level of clearance and the verifying of the temporal context and the spatial context, at least the subset of content generated by the large-language model to the user interface, in accordance with some embodiments. For example, the computing system 102 (e.g., content processor 106) may provide to the user interface 104 at least the subset of content generated by the LLM 110. This subset may be provided via the query response 155. The computing system 102 may provide this subset of content to the user interface 104 based at least on the verification of the level of clearance associated with the user identifier and the verification of the temporal and/or spatial contexts associated with the query 103.

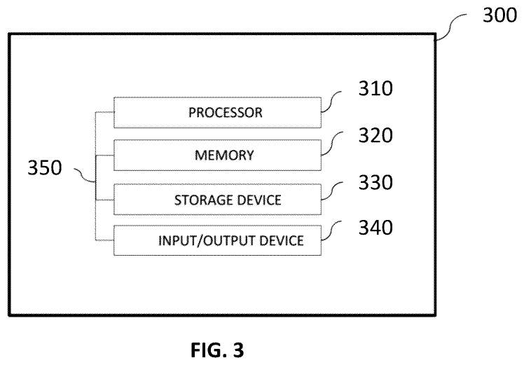

FIG. 3 depicts a diagram illustrating an example of a system 300 consistent with implementations of the current subject matter. In some implementations, the current subject matter may be configured to be implemented in a system 300. For example, the methods for role-based access control of LLM content described herein may be implemented using the system 300. The system may include a processor 310, a memory 320, a storage device 330, and an input/output device 340. Each of the components (e.g., processor 310, memory 320, storage device 330 and input/output device 340) may be interconnected using a system bus 350. The processor 310 may be configured to process instructions for execution within the system 300. In some implementations, the processor 310 may be a single-threaded processor. In alternate implementations, the processor 310 may be a multi-threaded processor.

The processor 310 may be further configured to process instructions stored in the memory 320 or on the storage device 330, including receiving or sending information through the input/output device 340. The memory 320 may store information within the system 100. In some implementations, the memory 320 may be a non-transitory computer-readable medium. In alternate implementations, the memory 320 may be a volatile memory unit. In yet some implementations, the memory 320 may be a non-volatile memory unit. The storage device 330 may be capable of providing mass storage for the system 300. In some implementations, the storage device 330 may be a computer-readable medium. In alternate implementations, the storage device 130 may be a floppy disk device, a hard disk device, an optical disk device, a tape device, non-volatile solid-state memory, or any other type of storage device. The input/output device 340 may be configured to provide input/output operations for the system 300. In some implementations, the input/output device 340 may include a keyboard and/or pointing device. In alternate implementations, the input/output device 340 may include a display unit for displaying graphical user interfaces.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed implementations may be implemented in various environments. Such environments and related applications may be specially constructed for performing the various processes and operations according to the disclosed implementations or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed implementations, or it may be more convenient to construct a specialized apparatus or system to perform the required methods and techniques.

Although ordinal numbers such as first, second and the like may, in some situations, relate to an order; as used in a document ordinal numbers do not necessarily imply an order. For example, ordinal numbers may be merely used to distinguish one item from another. For example, to distinguish a first event from a second event, but need not imply any chronological ordering or a fixed reference system (such that a first event in one paragraph of the description may be different from a first event in another paragraph of the description).

The foregoing description is intended to illustrate but not to limit the scope of the invention, which is defined by the scope of the appended claims. Other implementations are within the scope of the following claims.

These computer programs, which may also be referred to programs, software, software applications, applications, components, or code, include program instructions (i.e., machine instructions) for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium may store such program instructions non-transitorily, such as for example as would a non-transient solid-state memory or a magnetic hard drive or any equivalent storage medium. The machine-readable medium may alternatively or additionally store such machine instructions in a transient manner, such as would a processor cache or other random-access memory associated with one or more physical processor cores.

To provide for interaction with a user, the subject matter described herein may be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input.

The subject matter described herein may be implemented in a computing system that includes a back-end component, such as for example one or more data servers, or that includes a middleware component, such as for example one or more application servers, or that includes a front-end component, such as for example one or more client computers having a graphical user interface or a Web browser through which a user may interact with an implementation of the subject matter described herein, or any combination of such back-end, middleware, or front-end components. The components of the system may be interconnected by any form or medium of digital data communication, such as for example a communication network. Examples of communication networks include, but are not limited to, a local area network (“LAN”), a wide area network (“WAN”), and the Internet.

The computing system may include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. A computer-implemented method, the method comprising:
receiving a query to grant user access to content generated by a large-language model, the query including a user identifier;
verifying, based on the user identifier and using a first filter of a filter pipeline, a level of clearance associated with the user identifier;
granting, based at least on the verifying, the user access to at least a subset of the content generated by the large-language model;
verifying, using at least a second filter of the filter pipeline, a temporal context of the query and a spatial context of the query, wherein the temporal context comprises a time at which the query is received and wherein the spatial context comprises a location from which the query is received; and
providing, based at least on the verifying of the level of clearance and the verifying of the temporal context and the spatial context, at least the subset of content generated by the large-language model.

Example 2. The computer-implemented method of Example 1, wherein the user identifier comprises one or more of a login identifier, a time, or a location.

Example 3. The computer-implemented method of any of Examples 1-2, wherein the query is received from a user interface from which the query is generated.

Example 4. The computer-implemented method of any of Examples 1-3, wherein the verifying the level of clearance associated with the user identifier comprises comparing a first vector embedding corresponding to the user identifier to a second vector embedding corresponding to a source on which the large-language model is trained.

Example 5. The computer-implemented method of any of Examples 1-4, wherein the granting of the user access to at least the subset of the content generated by the large-language model comprises including the subset of the content in a query response.

Example 6. The computer-implemented method of any of Examples 1-5, wherein the providing at least the subset of content generated by the large-language model comprises providing a query response to a user interface.

Example 7. The computer-implemented method of any of Examples 1-6, further comprising training the large-language model using at least in part one or more documents that are non-public and/or confidential to an entity.

Example 8. A system comprising:
at least one processor; and
at least one memory including instructions which when executed by the at least one processor causes operations comprising:
receiving a query to grant user access to content generated by a large-language model, the query including a user identifier;
verifying, based on the user identifier and using a first filter of a filter pipeline, a level of clearance associated with the user identifier;
granting, based at least on the verifying, the user access to at least a subset of the content generated by the large-language model;
verifying, using at least a second filter of the filter pipeline, a temporal context of the query and a spatial context of the query, wherein the temporal context comprises a time at which the query is received and wherein the spatial context comprises a location from which the query is received; and
providing, based at least on the verifying of the level of clearance and the verifying of the temporal context and the spatial context, at least the subset of content generated by the large-language model.

Example 9. The system of Example 8, wherein the user identifier comprises one or more of a login identifier, a time, or a location.

Example 10. The system of any of Examples 8-9, wherein the query is received from a user interface from which the query is generated.

Example 11. The system of any of Examples 8-10, wherein the verifying the level of clearance associated with the user identifier comprises comparing a first vector embedding corresponding to the user identifier to a second vector embedding corresponding to a source on which the large-language model is trained.

Example 12. The system of any of Examples 8-11, wherein the granting of the user access to at least the subset of the content generated by the large-language model comprises including the subset of the content in a query response.

Example 13. The system of any of Examples 8-12, wherein the providing at least the subset of content generated by the large-language model comprises providing a query response to a user interface.

Example 14. The system of any of Examples 8-13, further comprising training the large-language model using at least in part one or more documents that are non-public and/or confidential to an entity.

Example 15. A non-transitory computer-storage medium including instructions which when executed by at least one processor causes operations comprising:
receiving a query to grant user access to content generated by a large-language model, the query including a user identifier;
verifying, based on the user identifier and using a first filter of a filter pipeline, a level of clearance associated with the user identifier;
granting, based at least on the verifying, the user access to at least a subset of the content generated by the large-language model;
verifying, using at least a second filter of the filter pipeline, a temporal context of the query and a spatial context of the query, wherein the temporal context comprises a time at which the query is received and wherein the spatial context comprises a location from which the query is received; and
providing, based at least on the verifying of the level of clearance and the verifying of the temporal context and the spatial context, at least the subset of content generated by the large-language model.

Example 16. The non-transitory computer-storage medium of Example 15, wherein the user identifier comprises one or more of a login identifier, a time, or a location.

Example 17. The non-transitory computer-storage medium of any of Examples 15-16, wherein the query is received from a user interface from which the query is generated.

Example 18. The non-transitory computer-storage medium of any of Examples 15-17, wherein the verifying the level of clearance associated with the user identifier comprises comparing a first vector embedding corresponding to the user identifier to a second vector embedding corresponding to a source on which the large-language model is trained.

Example 19. The non-transitory computer-storage medium of any of Examples 15-18, wherein the granting of the user access to at least the subset of the content generated by the large-language model comprises including the subset of the content in a query response.

Example 20. The non-transitory computer-storage medium of any of Examples 15-19, wherein the providing at least the subset of content generated by the large-language model comprises providing a query response to a user interface.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer-implemented method, the method comprising:
receiving a query to grant user access to content generated by a large-language model, the query including a user identifier;
verifying, based on the user identifier and using a first filter of a filter pipeline, a level of clearance associated with the user identifier;
granting, based at least on the verifying, the user access to at least a subset of the content generated by the large-language model;
verifying, using at least a second filter of the filter pipeline, a temporal context of the query and a spatial context of the query, wherein the temporal context comprises a time at which the query is received and wherein the spatial context comprises a location from which the query is received; and
providing, based at least on the verifying of the level of clearance and the verifying of the temporal context and the spatial context, at least the subset of content generated by the large-language model.

2. The computer-implemented method of claim 1, wherein the user identifier comprises one or more of a login identifier, a time, or a location.

3. The computer-implemented method of claim 1, wherein the query is received from a user interface from which the query is generated.

4. The computer-implemented method of claim 1, wherein the verifying the level of clearance associated with the user identifier comprises comparing a first vector embedding corresponding to the user identifier to a second vector embedding corresponding to a source on which the large-language model is trained.

5. The computer-implemented method of claim 1, wherein the granting of the user access to at least the subset of the content generated by the large-language model comprises including the subset of the content in a query response.

6. The computer-implemented method of claim 1, wherein the providing at least the subset of content generated by the large-language model comprises providing a query response to a user interface.

7. The computer-implemented method of claim 1 further comprising training the large-language model using at least in part one or more documents that are non-public and/or confidential to an entity.

8. A system comprising:
at least one processor; and
at least one memory including instructions which when executed by the at least one processor causes operations comprising:
receiving a query to grant user access to content generated by a large-language model, the query including a user identifier;
verifying, based on the user identifier and using a first filter of a filter pipeline, a level of clearance associated with the user identifier;
granting, based at least on the verifying, the user access to at least a subset of the content generated by the large-language model;
verifying, using at least a second filter of the filter pipeline, a temporal context of the query and a spatial context of the query, wherein the temporal context comprises a time at which the query is received and wherein the spatial context comprises a location from which the query is received; and
providing, based at least on the verifying of the level of clearance and the verifying of the temporal context and the spatial context, at least the subset of content generated by the large-language model.

9. The system of claim 8, wherein the user identifier comprises one or more of a login identifier, a time, or a location.

10. The system of claim 8, wherein the query is received from a user interface from which the query is generated.

11. The system of claim 8, wherein the verifying the level of clearance associated with the user identifier comprises comparing a first vector embedding corresponding to the user identifier to a second vector embedding corresponding to a source on which the large-language model is trained.

12. The system of claim 8, wherein the granting of the user access to at least the subset of the content generated by the large-language model comprises including the subset of the content in a query response.

13. The system of claim 8, wherein the providing at least the subset of content generated by the large-language model comprises providing a query response to a user interface.

14. The system of claim 8, further comprising training the large-language model using at least in part one or more documents that are non-public and/or confidential to an entity.

15. A non-transitory computer-storage medium including instructions which when executed by at least one processor causes operations comprising:
receiving a query to grant user access to content generated by a large-language model, the query including a user identifier;
verifying, based on the user identifier and using a first filter of a filter pipeline, a level of clearance associated with the user identifier;
granting, based at least on the verifying, the user access to at least a subset of the content generated by the large-language model;
verifying, using at least a second filter of the filter pipeline, a temporal context of the query and a spatial context of the query, wherein the temporal context comprises a time at which the query is received and wherein the spatial context comprises a location from which the query is received; and
providing, based at least on the verifying of the level of clearance and the verifying of the temporal context and the spatial context, at least the subset of content generated by the large-language model.

16. The non-transitory computer-storage medium of claim 15, wherein the user identifier comprises one or more of a login identifier, a time, or a location.

17. The non-transitory computer-storage medium of claim 15, wherein the query is received from a user interface from which the query is generated.

18. The non-transitory computer-storage medium of claim 15, wherein the verifying the level of clearance associated with the user identifier comprises comparing a first vector embedding corresponding to the user identifier to a second vector embedding corresponding to a source on which the large-language model is trained.

19. The non-transitory computer-storage medium of claim 15, wherein the granting of the user access to at least the subset of the content generated by the large-language model comprises including the subset of the content in a query response.

20. The non-transitory computer-storage medium of claim 15, wherein the providing at least the subset of content generated by the large-language model comprises providing a query response to a user interface.
